(19) United States
(12) Patent Application Publication
(10) Pub. No.: US 2012/0061017 A1
(43) Pub. Date: Mar. 15, 2012

(54) METHOD OF MANUFACTURING CAPACITIVE TOUCH SCREEN

(75) Inventors: Dong Sik Yoo, Seoul (KR); Hee Bum Lee, Gyunggi-do (KR); Kyoung Soo Chae, Seoul (KR); Yong Soo Oh, Gyunggi-do (KR); Jong Young Lee, Gyunggi-do (KR); Yun Ki Hong, Gyunggi-do (KR)

(73) Assignee: SAMSUNG ELECTRO-MECHANICS CO., LTD., Gyunggi-do (KR)

(21) Appl. No.: 13/231,784

(22) Filed: Sep. 13, 2011

(30) Foreign Application Priority Data
Sep. 14, 2010 (KR) 1020100089933

(51) Int. Cl. B32B 38/04; B32B 37/12; B32B 37/14

(52) U.S. Cl. 156/253; 156/60

(57) ABSTRACT

Disclosed herein is a method of manufacturing a capacitive touch screen, including: forming transparent electrodes on an upper surface of a lower transparent film; forming electrode wirings on a lower surface of an upper transparent film; and bonding the transparent electrodes to the electrodes wirings to be closely adhered to each other, whereby it prevents the transparent electrodes from being damaged or deformed due to heat, thereby making it possible to improve reliability and accuracy of the manufacturing process.

### CROSS REFERENCE TO RELATED APPLICATION

This application claims the benefit of Korean Patent Application No. 10-2010-0089933, filed on Sep. 14, 2010, entitled “Method Of Manufacturing Capacitive Touch Screen”, which is hereby incorporated by reference in its entirety into this application.

### BACKGROUND OF THE INVENTION

1. Technical Field

The present invention relates to a method of manufacturing a capacitive touch screen.

2. Description of the Related Art

Current techniques for input devices exceed the level of fulfilling general functions and thus are progressing towards techniques related to high reliability, durability, innovation, designing and manufacturing. To this end, a touch screen has been developed as an input device capable of inputting information such as text and graphics.

The touch screen is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

The touch screen may be classified into a resistive type, a capacitive type, an electromagnetic type, a surface acoustic wave (SAW) type, and an infrared type. The type of touch screen selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch screen. In particular, resistive and capacitive types are prevalently used at the present time.

The capacitive touch screen has a structure in which a transparent electrode is formed between first and second transparent films, which are upper and lower transparent films. More specifically reviewing the configuration of the capacitive touch screen as described above, the first and second transparent films, which are the upper and lower transparent films, are divided into an active region in which the transparent electrodes are formed and an inactive region formed at the edges thereof, wherein the transparent electrodes are formed of electrode patterns formed so as to recognize coordinates. Electrode wirings connecting the electrode patterns of the transparent electrodes are formed in the inactive region.

Herein, the transparent electrode is made of indium tin oxide (ITO), indium zinc oxide (IZO) or the like, and the electrode wirings are mainly made of silver (Ag).

Reviewing a method of manufacturing the capacitive touch screen, the transparent electrodes are formed in the active region of a lower transparent substrate and then an upper transparent substrate is bonded thereto, while the electrode wirings are formed in the inactive region, by way of example.

According to the manufacturing method as described above, a problem occurs in that the transparent electrodes may be damaged or deformed due to high temperature heat during an annealing process for forming the electrode wirings.

### SUMMARY OF THE INVENTION

The present invention has been made in an effort to provide a method of manufacturing a capacitive touch screen preventing transparent electrodes from being damaged or deformed due to heat during an annealing process for forming electrode wirings.

A method of manufacturing a capacitive touch screen according to a preferred embodiment of the present invention, includes: (A) forming transparent electrodes on a first transparent film; (B) forming electrode wirings on a second transparent film; and (C) bonding the transparent electrodes to the electrode wirings to be connected to each other.

Herein, at the step (C), the lower surface of the electrode wirings may be applied with a double-sided conductive adhesive and then be bonded to the transparent electrode.

At the step (C), the transparent electrodes may be bonded to the electrode wirings by applying an optical clear adhesive between the second transparent film and the transparent electrodes.

The optical clear adhesive may be any one of an optical clear adhesive (OCA) and a pressure sensitive adhesive (PSA).

The step (C) may include: forming and bonding an non-conductive adhesive layer on any one side of the transparent electrode and the electrode wiring so that the transparent electrode and the electrode wiring correspond to each other; forming a hole on a position of the non-conductive adhesive layer, the position in which the transparent electrode is connected to the electrode wiring; filling the hole with a conductive metal; and bonding the first transparent film to the second transparent film so that the transparent electrode and the electrode wiring are connected to each other by the conductive metal filled in the hole.

The conductive metal may be made of silver (Ag).

The transparent electrode may be made of a conductive polymer (pedot).

The electrode wiring may be made of silver (Ag).

### BRIEF DESCRIPTION OF THE DRAWINGS

FIG. 1 is a process diagram showing a method of manufacturing a capacitive touch screen to which the present invention is applied;

FIGS. 2 and 3 are process diagrams showing a first embodiment of a method of manufacturing a capacitive touch screen to which the present invention is applied;

FIGS. 4 and 5 are process diagrams showing a second embodiment of a method of manufacturing a capacitive touch screen to which the present invention is applied; and

FIGS. 6 to 9 are process diagrams showing a third embodiment of a method of manufacturing a capacitive touch screen to which the present invention is applied.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. In describing the present invention, a detailed description of related known functions or configurations will be omitted so as not to obscure the gist of the present invention.

Hereinafter, preferred embodiments of the present invention will be described in detail with reference to the accompanying drawings.

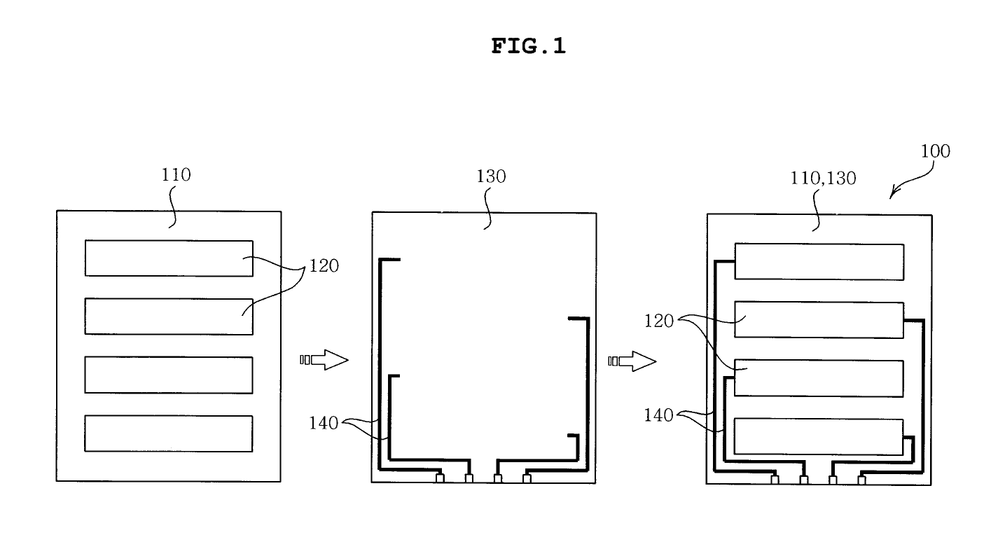

A method of manufacturing a capacitive touch screen 100 according to the present invention is configured to include: (A) forming transparent electrodes 120 on a first transparent film 110; (B) forming electrode wirings 140 on a lower surface of a second transparent film 130; and (C) bonding the transparent electrodes 120 to the electrode wirings 140 to be connected to each other, as shown in FIG. 1.

At the (A) forming the transparent electrodes 120 on the first transparent film 110, the transparent electrodes 120 are formed in an active region of the first transparent film 110. The transparent electrodes 120, which generate electrical signals in response to physical touch from the outside, have a shape in which a number of electrode patterns are arranged at a predetermined interval. For example, the electrode patterns are alternately disposed to each other and formed to be connected to each other in a unit in which X coordinates are the same and in a unit in which Y coordinates are the same.

The first transparent film 110 may be made of glass, polyethylene terephthalate, or the like.

The transparent electrode 120 forms an electrode pattern using a conductive polymer (pedot) as an embodiment.

The conductive polymer, which is a material for forming the transparent electrode 120, has an advantage in that a film having a large area can be prepared at low costs, meeting the demand to make a display large and reduce costs thereof. In addition, the conductive polymer has flexibility and thus, the touch screen or an electronic paper and a transparent electrode of an OLED, which are next generation displays, may endure warpage.

The transparent electrode 120 may also be made of indium tin oxide (ITO), indium zinc oxide (IZO), Al-doped ZnO (AZO), carbon nano tube (CNT), silver (Ag) or copper transparent ink, or the like, in addition to the conductive polymer.

At the (B) forming the electrode wirings 140 on the lower surface of the second transparent film 130, the electrode wirings 140 are formed in an inactive region of the second transparent film 130. The inactive region, in which is the electrode wirings are formed, corresponds to edge portions of the substrate.

The second transparent film 130 may be made of glass, polyethylene terephthalate, or the like.

The electrode wirings 140 are made of silver (Ag) by way of example.

At the (C) bonding the transparent electrodes 120 to the electrode wirings 140, the electrode patterns of the transparent electrode 120 should be connected and bonded to the electrode wirings 140 to be electrically conducted, while matching each other.

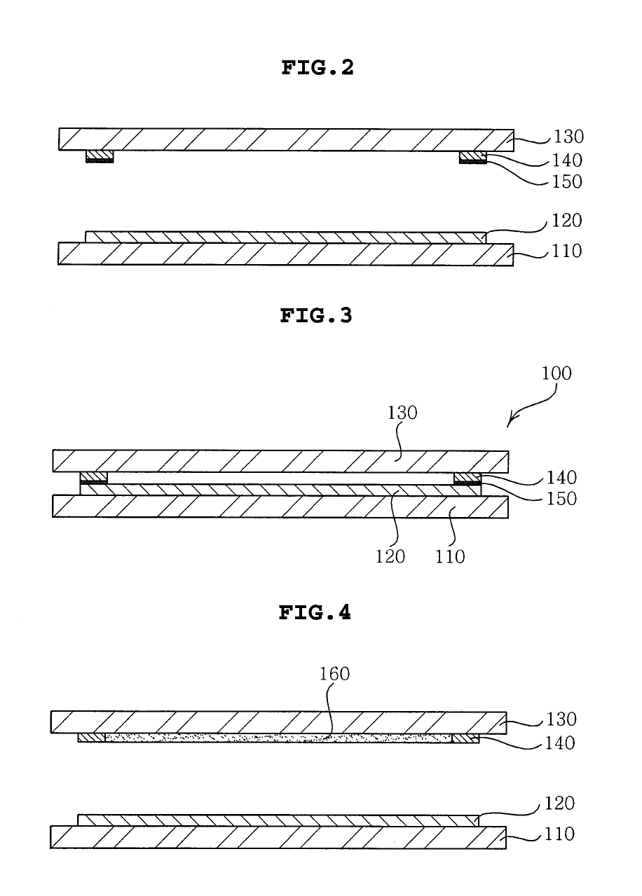

As a first preferred embodiment in which the transparent electrodes 120 are connected to the electrode wirings 140, the electrode wirings 140 may be applied with a double-sided conductive adhesive 150 and then be bonded to the transparent electrodes 120, as shown in FIGS. 2 and 3. At this time, each of the electrode wirings should be applied in order to prevent electrical short with other electrode wirings 140 while applying the electrode wirings 140 with the double-sided conductive adhesive 150.

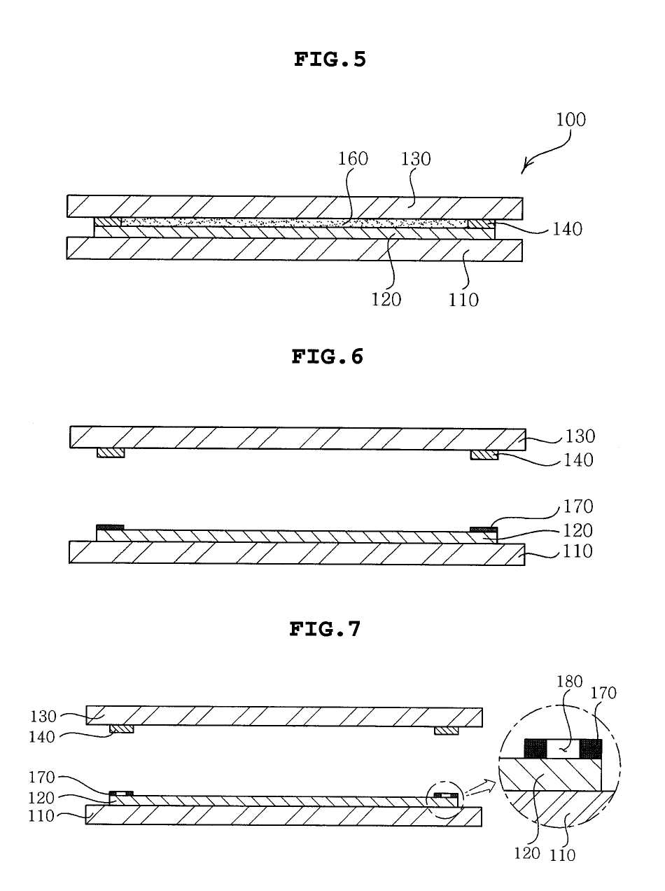

As a second preferred embodiment in which the transparent electrodes 120 are connected to the electrode wirings 140, they may be bonded to each other by applying an optical clear adhesive 160 between the transparent electrodes 120 of the second transparent film 130, as shown in FIGS. 4 and 5. For example, the electrode wirings 140 may be bonded to the transparent electrodes 120 in a state in which the optical clear adhesive 160 is applied on an inner side of a lower surface of the second transparent film 130. At this time, while applying the optical clear adhesive 160 on the inner side of the lower surface of the second transparent film 130, the optical clear adhesive 160 is applied at a uniform thickness, without being applied to the electrode wirings 140.

The optical clear adhesive 160 may use any one of an optical clear adhesive (OCA) and a pressure sensitive adhesive (PSA) by way of example.

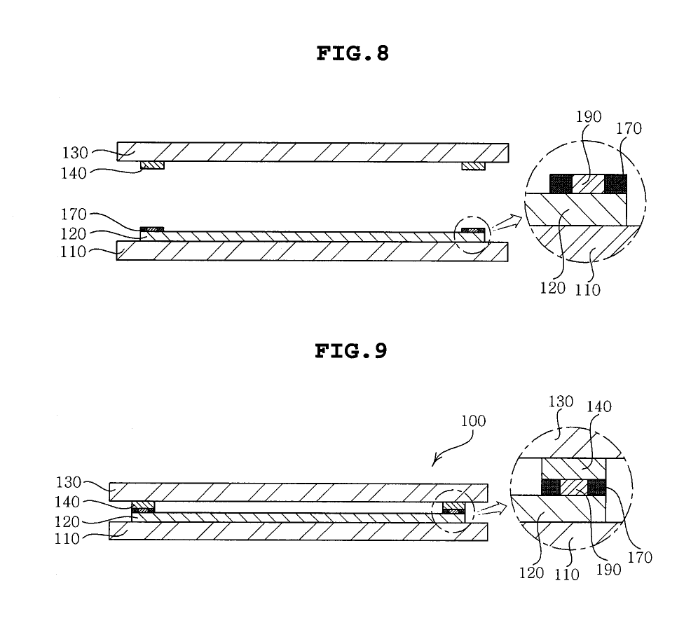

As a third preferred embodiment in which the transparent electrodes 120 are connected to the electrode wirings 140, as shown in FIGS. 6 to 9, it may include: forming and bonding a non-conductive adhesive layer 170 on any one side of the transparent electrode 120 and the electrode wiring 140 so that the transparent electrode 120 and the electrode wiring 140 correspond to each other; forming a hole 180 by punching a position of the non-conductive adhesive layer 170, the position in which the transparent electrode 120 is connected to the electrode wiring 140; filling the hole 180 with a conductive metal 190; and bonding the first transparent film 110 to the second transparent film 130 so that the transparent electrode 120 is connected to the electrode wiring 140 by the conductive metal 190 filled in the hole 180.

FIG. 6 shows the forming the non-conductive adhesive layer 170 on any one side of the transparent electrode 120 and the electrode wiring 140 so that the transparent electrode 120 and the electrode wiring 140 correspond to each other. In this configuration, the non-conductive adhesive layer 170 is shown to be formed on the side of the transparent electrode 120; however, the non-conductive adhesive layer 170 may also be formed on the side of the electrode wiring 140. When the transparent electrode 120 is bonded to the electrode wiring 140 using the non-conductive adhesive layer 170 according to the present embodiment, the hole 180 is machined in the non-conductive adhesive layer 170 and then is filled with the conductive metal 190 in a step to be described below in order to electrically connect the transparent electrode 120 to the electrode wiring 140.

FIG. 7 shows the forming the hole 180 by punching a position of the non-conductive adhesive layer 170, the position in which the transparent electrode 120 is connected to the electrode wiring 140. The reason is that the transparent electrode 120 and the electrode wiring 140 should be electrically conducted with each other. When the transparent electrode 120 is bonded to the electrode wiring 140 by the non-conductive adhesive layer 170, the hole 180 is machined on an appropriate position of the non-conductive adhesive layer 170 in order to electrically connect the transparent electrode 120 to the electrode wiring 140. In order to electrically connect the transparent electrode 120 to the electrode wiring 140, the hole 180 may be machined by punching a portion of the non-conductive adhesive layer 170. Preferably, the hole is formed by punching a central portion of the adhesive layer 170, thereby making it also possible to improve adhesion between the transparent electrode 120 and the electrode wiring 140.

FIG. 8 shows the filling the hole 180 with the conductive metal 190. The hole 180 machined in order to electrically connect the transparent electrode 120 to the electrode wiring 140 is filled with the conductive metal 190. As the conductive metal 190 filled in the hole 180, silver (Ag) may be used and copper (Cu), platinum (Pt), or a combination thereof may also be used.

FIG. 9 shows the bonding the first transparent film 110 to the second transparent film 130 so that the transparent electrode 120 is connected to the electrode wiring 140 by the conductive metal 190 filled in the hole 180. When the first transparent film 110 is bonded to the second transparent film 130, they are bonded to each other so that the transparent electrode 120 faces the electrode wiring 140. At this time, it is preferable that the first transparent film 110 is bonded to the second transparent film 130 so that the transparent electrode 120 may be bonded to the electrode wiring 140 through the conductive metal 190 filled in the hole 180 formed on the non-conductive adhesive layer 170.

By the method that the transparent electrode 120 and the electrode wiring 140 are each formed on the first and second transparent films 110 and 130 and then bonded to each other, it prevents the electrode pattern of the transparent electrode 120 from being damaged or deformed due to high-temperature heat, thereby making it possible to improve reliability and accuracy of the manufacturing process.

According to the method of manufacturing a touch screen of the present invention, the transparent electrode and the electrode wirings are each formed on the first and second transparent films vertically corresponding thereto and then bonded to each other, and thereby it prevents the transparent electrode from being damaged or deformed, thereby making it possible to improve reliability and accuracy of the manufacturing process.

Although the preferred embodiments of the present invention have been disclosed for illustrative purposes, they are for specifically explaining the present invention and thus a method of manufacturing a capacitive touch screen according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A method of manufacturing a capacitive touch screen, comprising:
(A) forming transparent electrodes on a first transparent film;
(B) forming electrode wirings on a second transparent film; and
(C) bonding the transparent electrodes to the electrode wirings to be connected to each other.

2. The method of manufacturing a capacitive touch screen as set forth in claim 1, wherein at the step (C), the electrode wirings are applied with a double-sided conductive adhesive and then are bonded to the transparent electrode.

3. The method of manufacturing a capacitive touch screen as set forth in claim 1, wherein at the step (C), the transparent electrodes are bonded to the electrode wirings by applying an optical clear adhesive between the second transparent film and the transparent electrode.

4. The method of manufacturing a capacitive touch screen as set forth in claim 3, wherein the optical clear adhesive is any one of an optical clear adhesive (OCA) and a pressure sensitive adhesive (PSA).

5. The method of manufacturing a capacitive touch screen as set forth in claim 1, wherein the step (C) includes:
forming and bonding an non-conductive adhesive layer on any one side of the transparent electrode and the electrode wiring so that the transparent electrode and the electrode wiring correspond to each other;
forming a hole on a position of the non-conductive adhesive layer, the position in which the transparent electrode is connected to the electrode wiring;
filling the hole with a conductive metal; and
bonding the first transparent film to the second transparent film so that the transparent electrode and the electrode wiring are connected to each other by the conductive metal filled in the hole.

6. The method of manufacturing a capacitive touch screen as set forth in claim 5, wherein the conductive metal is made of silver (Ag).

7. The method of manufacturing a capacitive touch screen as set forth in claim 1, wherein the transparent electrode is made of a conductive polymer.

8. The method of manufacturing a capacitive touch screen as set forth in claim 1, wherein the electrode wiring is made of silver (Ag).
